(19) United States
(12) Patent Application Publication
(10) Pub. No.: US 2015/0330866 A1
(43) Pub. Date: Nov. 19, 2015

(54) METHOD AND SYSTEM FOR MONITORING OPERATING CONDITIONS IN A STEAM GENERATOR

(71) Applicant: GENERAL ELECTRIC COMPANY, Schenectady, NY (US)

(72) Inventors: Xingwei YANG, Clifton Park, NY (US); Aditya KUMAR, Schenectady, NY (US); Ali CAN, Troy, NY (US); Guanghua WANG, Clifton Park, NY (US)

(21) Appl. No.: 14/652,708

(22) PCT Filed: Dec. 20, 2013
(86) PCT No.: PCT/US13/76764

§ 371 Date: Jun. 16, 2015

(30) Foreign Application Priority Data
Dec. 20, 2012 (CA) 2799869

(51) Int. Cl. G01M 11/08; F01D 25/28

(52) U.S. Cl. CPC G01M 11/081; F01D 25/285; G01M 11/083

(57) ABSTRACT

A system and method for monitoring operating conditions of tubes in a steam generator. The system comprises sensors, affixed to the tubes, for detecting one or more of mechanical strains, pressures, and temperatures in the tubes; or a camera positioned in the steam generator, the camera for capturing thermal images of the tubes; or both the sensors and the camera. The system also comprises one or more computers connected to the sensors, or the camera, or both the sensors and the camera, the computers for receiving one or more of the mechanical strains, pressures, temperatures, and thermal images, and monitoring the operating conditions of the tubes. The method comprises receiving, at one or more times, one or more of pressures, mechanical strains, temperatures, and infrared photon counts of the tubes; identifying segments of the tubes to which pertains the pressures, mechanical strains, temperatures, and infrared photon counts; and monitoring the operating conditions of the tubes.

### CROSS-REFERENCE TO RELATED APPLICATIONS

This application claims priority to Canadian Patent Application 2,799,824 titled SYSTEM AND METHOD FOR MONITORING STEAM GENERATOR TUBE OPERATING CONDITIONS filed on Dec. 20, 2012; Canadian Patent Application 2,799,830 titled METHOD AND SYSTEM FOR MONITORING STEAM GENERATION TUBE OPERATION CONDITIONS filed on Dec. 20, 2012; and Canadian Patent Application 2,799,869 titled SYSTEM AND METHOD FOR DETERMINING LOCATION DATA FOR PIPES IN A STEAM GENERATOR filed on Dec. 20, 2012, all of which are incorporated herein by reference in their entirety.

### FIELD

The present disclosure relates generally to steam generators. More particularly, the present disclosure relates to monitoring steam generators during operation.

### BACKGROUND

The following background discussion is not an admission that anything discussed below is citable as prior art or common general knowledge.

A steam generator is used in various applications and processes including, for example, for driving a turbine to create electricity, or in steam assisted gravity drainage for recovery of oil in oil sands as are found in Alberta, Canada.

A heat recovery steam generator (HRSGs) is a type of steam generator that uses heat exchangers to recover heat from a hot gas stream to generate steam. A type of HRSG is a once-through steam generator (OTSG). OTSGs are favoured in some oil sands applications. Unlike HRSGs, OTSGs do not have boiler drums.

An OTSG comprises one or more high carbon steel tubes or tube coils that pass through different, but connected, heating sections. The tubes can also be described as pipes. The sections can be radiant and convection sections. Water is pumped in a continuous path through the tubes and heated in the different sections. Heat is generated by combusting fuel in a combustion chamber. The combustion chamber is located directly adjacent to the radiant section. The heat from the combustion chamber is forced through the radiant section, through the convection section, and out an exhaust stack.

In an OTSG, cold or mild temperature water is first pumped through the convection section where heat exchanges with the hot combustion flue gas to pre-heat the water. To maximize heat transfer to the water, the tubes in the convection section are coiled and tightly arranged next to one another in stacks or layers to maximize water surface area to water volume. The pre-heated water or water/steam mixture exits the convection section and continues to the radiant section where it is further heated by the hot air and by the radiation emitted from the combustion of fuel. The radiant section consists of a large number of tubes in a shell through which hot air and combusted gas are forced. The tubes in the radiant section are straight and arranged circumferentially around the interior of the shell to form a hollow cylindrical structure. No tubes are present in the centre of the cylinder so as to allow combusted gas and hot air to pass therethrough.

HRSG and OTSG are harsh environments. Radiant sections can experience up to 1000 degrees Celsius, and steam convection sections can experience between 500-1000 degrees Celsius. During operation, because of the extreme heat, deposits can accumulate in the interior of the tubes or tube coils. The accumulation of deposits is called fouling and is caused by particles or scaling in the water, namely, silica, carbonate, and other minerals. Heat accelerates the accumulation of deposits or fouling.

Fouling may reduce the performance of the HRSG and OTSG by degrading the thermal exchange efficiency of the tubes, or parts thereof, at different radiant and convection sections. Deposits on the interior of the tubes also restrict the flow of water. Accordingly, localized fouling can product hot spots that continue to foul and may lead to a ruptured tube. Ruptured tubes require an expensive and time-consuming shut down of the steam generator to repair or replace the tube.

Early detection of fouling may permit a deteriorated tube or tubes to be repaired or replaced during scheduled maintenance. Fouling, however, is difficult to detect due to the high temperatures, hazardous conditions, and physical restrictions in accessing an HRSG and OTSG.

### INTRODUCTION

A system and method for monitoring operating conditions of tubes in a steam generator is described. The system comprises sensors, affixed to the tubes, for detecting one or more of mechanical strains, pressures, and temperatures in the tubes or the sensors; or a camera positioned in the steam generator, the camera for capturing images of the tubes relatable to temperature; or both the sensors and the camera. The system also comprises one or more computers connected to the sensors, or the camera, or both the sensors and the camera, the computers for receiving one or more signals relatable to one or more of the mechanical strains, pressures, and temperatures, and monitoring an operating condition of the tubes. The method comprises receiving, at one or more times, one or more signals relatable to one or more of pressures, mechanical strains, and temperatures of the tubes; identifying segments of the tubes to which the signals pertain; and monitoring an operating condition of the tubes.

### BRIEF DESCRIPTION OF THE DRAWINGS

Embodiments of the present disclosure will now be described, by way of example only, with reference to the attached Figures.

FIG. 1A is an illustration of a once-through steam generator.

FIG. 1B is a cross section of a convection section of a circuit of the OTSG depicted in FIG. 1A.

FIG. 1C is a cross section view of a radiant section of a circuit of the OTSG depicted in FIG. 1A.

FIG. 2 is a schematic depiction of a monitoring system and a portion of the OTSG of FIG. 1A according to an embodiment of the present invention.

FIG. 3 is a perspective side view of a segment of a fiber optic sensor.

FIG. 4 is a cross section view of an exemplary embodiment of a fiber optic sensor disposed within a hermetical cable package.

FIG. 5 is a perspective side view of a cable package disposed within a guide tube and affixed to a tube according to an embodiment of the present invention.

FIG. 6 is a flowchart of a process for monitoring the operating conditions of tubes with a fiber optic sensor in the OTSG of FIG. 1A in accordance with an embodiment of the present invention.

FIG. 7 is a block diagram of a system for monitoring the conditions in the OTSG of FIG. 1A.

FIG. 8 is a flowchart of an example method for determining location data for tubes of the OTSG of FIG. 1A.

FIG. 9 is a view of sample images for calibrating a camera according to the method of FIG. 8.

FIG. 10 through FIG. 12 are views of camera lens distortion parameters for calibrating a camera according to the method of FIG. 8.

FIG. 13 and FIG. 14 are perspective views of tubes in the interior of a radiant section of a OTSG as shown in FIG. 1C, showing the identification of landmarks, and a projection from the landmarks, respectively, according to the method of FIG. 8.

FIG. 15 is a schematic view of a tube template transformation for adjusting a location according to the method of FIG. 8.

FIG. 16 and FIG. 17 are schematic views of projected locations of the tube templates for adjusting location data according to the method of FIG. 8.

FIG. 18 through FIG. 21 are perspective views of tubes in the interior of a OTSG, depicting location data for tubes, according to the method of FIG. 8.

FIG. 22 shows another example embodiment of a system for monitoring the operating conditions of a once-through steam generator as shown in FIG. 1A.

### DETAILED DESCRIPTION

In the following description, for purposes of explanation, numerous details are set forth in order to provide a thorough understanding of the embodiments. However, it will be apparent to one skilled in the art that these specific details are not required. In other instances, well-known electronic structures and circuits are shown in block diagram form in order to not obscure the understanding. For example, specific details are not provided as to whether the embodiments described herein are implemented as a software routine, hardware circuit, firmware, or a combination thereof.

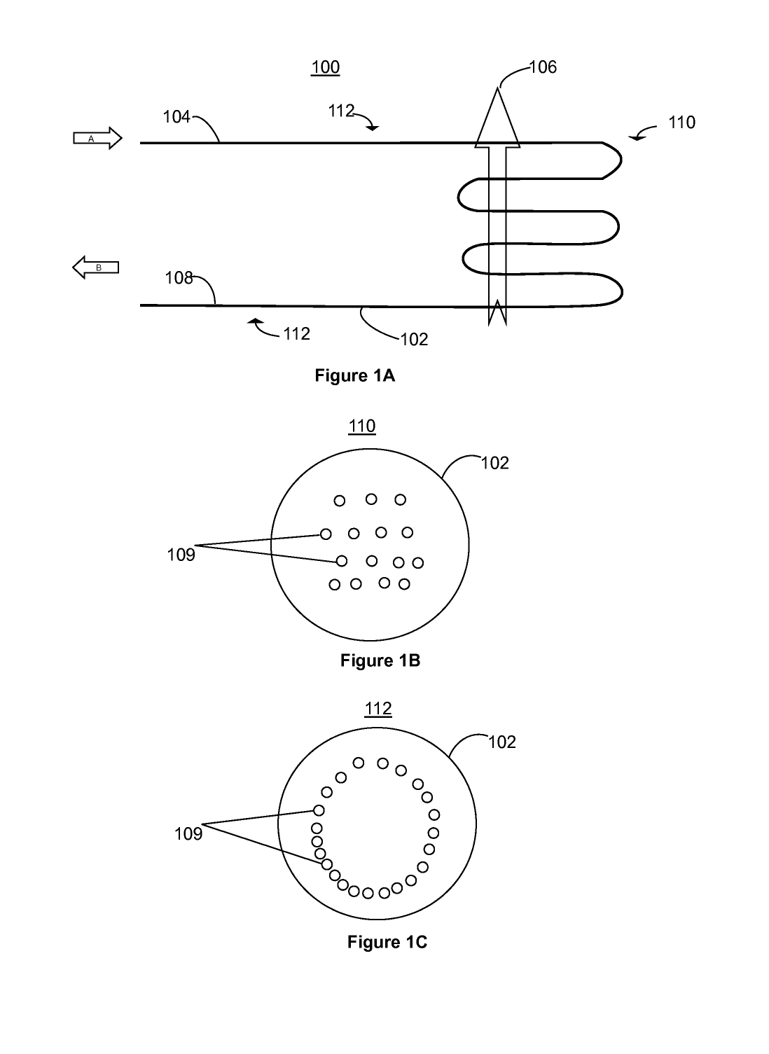

FIG. 1A illustrates an example HRSG, in particular a once-through steam generator (OTSG) 100, for use with a method and system for monitoring the operating conditions therein. An HRSG is an energy recovery heat exchange system that recovers heat from a hot gas stream generated by a gas turbine. The energy from the hot gas stream can generate steam for electricity production or for various industrial processes. A specialized type of HRSG that does not include a boiler drum is an OTSG. An OTSG converts water (also referred to as feed water) to high-pressure and high-temperature steam.

In the OTSG 100, cold or pre-heated water may follow a continuous path without segmented sections through components such as economizers, evaporators, and super heaters. In the OTSG 100, preheating, evaporation, and superheating of the water may take place consecutively, within one continuous circuit 102. Water is pumped through the circuit 102, shown as arrow “A” in FIG. 1A, at a cold end 104 of the OTSG 100. As the water flows through the OTSG 100, it is heated and changes phase as it extracts heat from the gas flow shown as arrow 106. The gas flow 106 can be created by a gas turbine. The circuit 102 includes one or more tubes that are exposed to one or more convection sections 110, and one or more radiant sections 112, also referred to as furnaces, together referred to as heating sections. Superheated steam flows through the hot end 108 of the OTSG 100, shown as arrow “B” in FIG. 1A.

For example, the temperature in the radiant section 112, or furnace, of an OTSG can reach up to 1,000° C. (degrees Celsius). The water or steam in the interior of tubes used in an OTSG may reach 300° C. and a pressure of 1800 pounds per square inch gage (psig).

Individual sections of the OTSG 100 may be larger or smaller based on the heat load received from the gas turbine. The location of the tubes as built or observed during operation may differ from locations according to computer-aided design (CAD) models of the HRSG system or components thereof. Furthermore, the location of the tubes may be affected due to expansion and contraction of tubes due to operating conditions and heat, and manufacturing variations.

FIG. 1B shows a cross-section of the convection section 110 of the circuit 102 as shown in FIG. 1A. Disposed within the circuit 102 are one or more tubes 109 which run the length of the circuit. Between the tubes 109 themselves and the walls or shell of the circuit 102 is air. To maximize heat transfer to the water in the tubes 109, the coiled carbon steel tubes 109 in the convection section 110 are tightly arranged next to one another in stacks or layers to maximize water surface area to water volume.

FIG. 1C shows a cross-section of the radiant section 112 of the circuit 102 as shown in FIG. 1A. Disposed within the circuit 102 are one or more tubes 109 which run the length of the circuit 102. Between the tubes 109 themselves and the walls of the circuit 102 is air. The radiant section 112 consists of a large number of tubes 109 through which hot air and combusted gas are forced. The tubes 109 in the radiant section 112 are straight and arranged circumferentially around the interior of the radiant section 112 to form a hollow cylindrical structure. No tubes are present in the centre of the cylinder so as to allow combusted gas and hot air to pass therethrough.

OTSGs are harsh environments that can experience up to 1000 degrees Celsius in the radiant section 112 and 500-1000 degrees Celsius in a steam convection section 110. During operation, the harsh environment can cause deposits to accumulate in the interior of the tubes or tube coils that carry water or steam or a mixture thereof, through the sections of the OTSG. Fouling may reduce the performance of the HRSG and OTSG by degrading the thermal exchange efficiency of the tubes, or parts thereof, in the radiant and convection sections. Deposits on the interior of the tubes also restrict the flow of water. Localized fouling can produce hot spots increase the rate of fouling and may lead to a ruptured tube.

Despite the need to monitor the conditions in an OTSG and HRSG, generally, and to detect tube fouling in an OTSG and HRSG, specifically, during operation, it can be difficult to do either. This is because the sections 110, 112 are inaccessible to individuals due to high temperatures and harsh conditions therein. The sections may also be inaccessible to individuals due to physical restrictions. Even if the physical restrictions could be overcome, the high temperatures which occur in the sections during operation would require the OTSG/HRSG to be shutdown prior to entry.

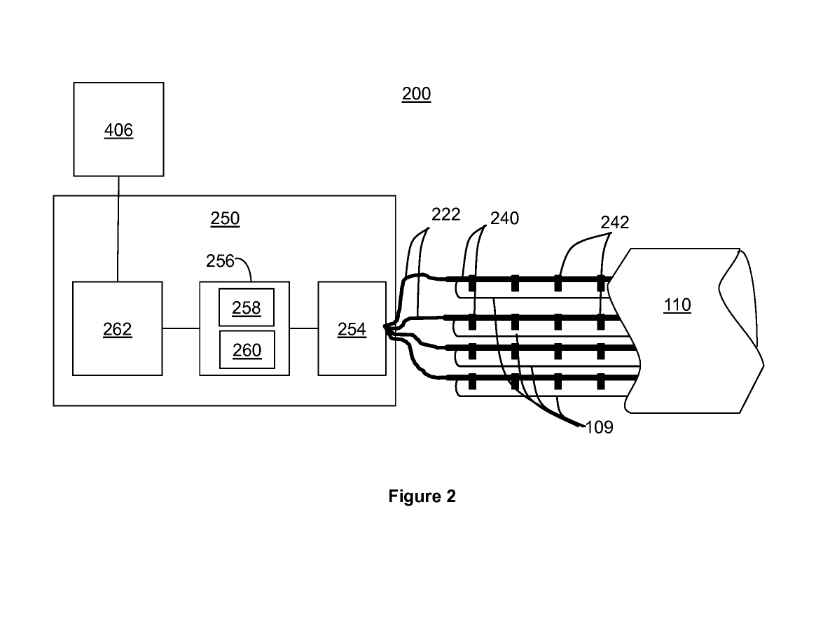

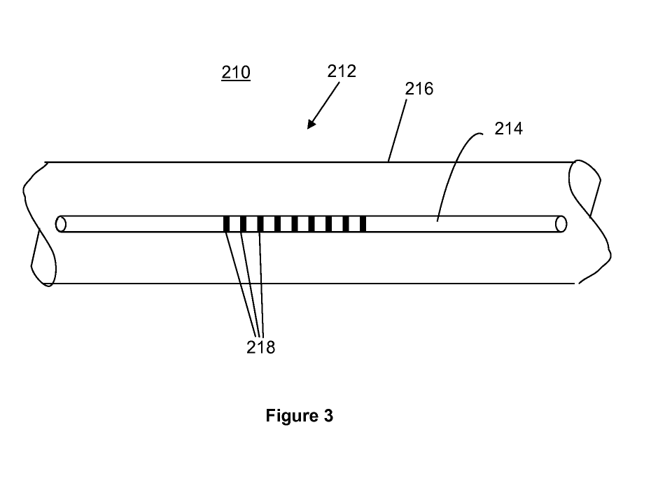

FIG. 2 shows a system 200 for monitoring the conditions in an OTSG and HRSG in accordance with an embodiment of the present disclosure. The system comprises a plurality of fiber sensing cable packages 222 affixed to the tubes 109 of the radiant section 112 of the OTSG 100 of FIG. 1A. The fiber sensing cable packages 222 sense strain in the tubes including, without limitation, temperature and pressure strain. The cable packages 222 are affixed to the tubes 109 by shims 242 and connected to instrumentation 250 for monitoring the operating conditions of the tubes 109. The sensing cable packages 222 run along the lengths of at least a portion of each tube 209 within the guide tubes 240. The sensing cable packages 222 comprise fiber optic sensors 210 which are optically connected to a junction box 254 which transmits signals from the fiber optic sensors 210 to a signal processing unit 256, such as an optical sensing interrogator, sm125 from Micron Optics Inc. The optical sensing interrogator 256 may comprise a broadband or tunable light source 258 and a photodetector 260. The photodetector 260 can be arranged as an array to provide multi-channel optical spectral analysis functionality. For high accuracy spectral analysis, an optical sensing interrogator is normally integrated with a NIST standard gas calibration cell. The optical sensing interrogator 256 is connected to a central processing unit (also known as a computer or CPU) 262 which includes a display 264. The CPU 262 can be connected to a network 406. The light source 258 emits a broadband spectrum light. The spectrum of light emitted by the light source 258 can be controlled by either tuning a filter or by tuning a laser cavity. In an example embodiment the light source 258 is a tunable fiber laser that can provide 80-100 nm wide spectral range.

FIG. 3 shows the fiber optic sensor 210 of FIG. 2. The fiber optic sensor 210 comprises a strand of optical fiber 212 that reflects particular wavelengths of light and transmits all other wavelengths of light. The optical fiber 212 comprises a core 214 and a cladding 216. The cladding 216 comprises a material with a low refractive index, such as silicon dioxide, which encases the core 214, and an outer coating material, such as polyimide or metal. To achieve the desired reflective/transmission properties in the optical fiber 212, the refractive index of the core 214 is periodically varied. These variations are known as Bragg gratings (gratings) 218. Gratings 218 can be created by, for example, inscribing the core 214 with an intense ultraviolet source such as an ultraviolet laser. U.S. Pat. No. 7,574,075, incorporated herein by reference in its entirety, describes a fiber Bragg grating and fabrication method of same. The gratings are, generally, 5-10 millimeters in length and the distance between the gratings is, generally, 50 millimeters.

Because of the harsh environment and extreme heat in an OTSG 100, the fiber optic sensor 210 is preferably a high-temperature fiber optic sensor. An example of a high-temperature fiber optic sensor 210 is a tetrahedral fiber Bragg grating sensor. U.S. Pat. No. 8,180,185, which is herein incorporated by reference in its entirety, describes a tetrahedral fiber optic sensor for a harsh environment. The tetrahedral fiber optic sensor comprises microcrystalline and silicon dioxide tetrahedral structure gratings which are better able to tolerate high temperatures while keeping their structural integrity and reducing thermal drift in the wavelengths of light reflected and refracted by the gratings.

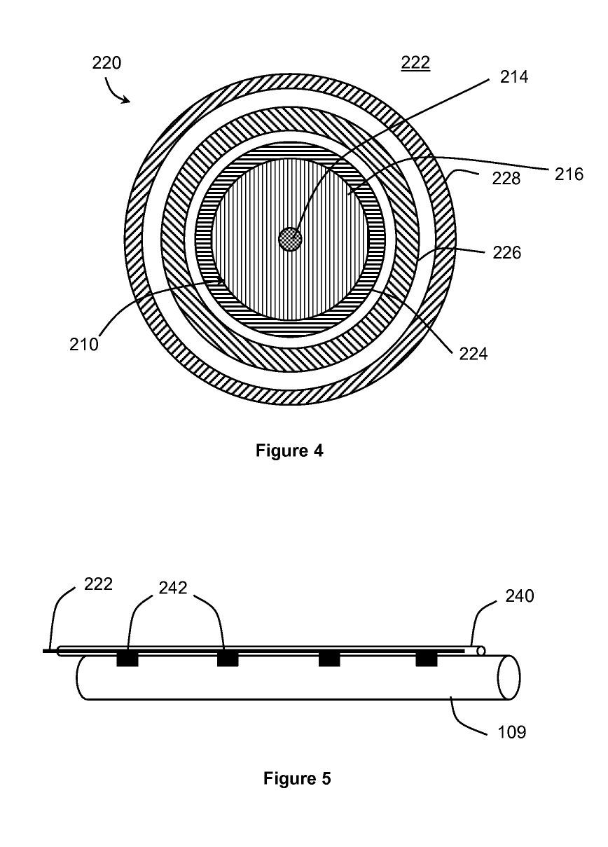

FIG. 4 shows the fiber optic sensor 210 of FIG. 3 for use in high temperature environments. The fiber optic sensor 210 is encased in a hermetical cable package 220 which, together, form a sensor cable package 222, according to the present invention. The hermetical cable package 220 comprises three concentric metal layers. An inner metal layer 224 is disposed circumferentially about the fiber optic sensor 210. The inner metal layer 224 comprises gold, nickel and aluminum and has a thickness of 10-20 micron meters. A middle metal layer 226 is disposed circumferentially about the inner metal layer 224. The middle metal layer 226 comprises stainless steel or INCONEL and has an outside diameter of less than 1 millimetre and an inside diameter of more than 0.25 millimetres. The outer metal layer 228 is disposed circumferentially about the middle metal layer 226 and has an outside diameter of less than 1.5 millimetres and an inner diameter of more than 1 millimetre. The outer metal layer 228 is composed of INCONEL. The gaps between the three metal layers can contain air, or thermal conductive filling material, or fluid. A conventional pulling method is used to thread the fiber optic sensor 210 through the inner metal layer 224.

FIG. 5 shows an example embodiment of the sensing cable package 222, substantially the same as shown in FIG. 4, affixed to, or integrated with, the tube 109 according to the present invention. Prior to affixing or integrating the sensing cable package 222 to the tube 109, the surface of the tube 109 is first cleaned of all oxides. A guide tube 240 is affixed to the tube 109 by spot welding at multiple locations along the tube 109. The tube 109 and the guide tube 240 are welded together using shims 242 therebetween so that it affixes the sensing cable package 222 along the length of the tube 109. A shim 242 may be approximately 20 mm wide and have a curvature on one of its faces sufficient to adapt to the curvature of the tubes 109 to which it is being affixed. The sensing cable package 222 is inserted or threaded into the guide tube 240. In an example embodiment, a sensing cable package 222 can be from 20 to 30 feet in length. Multiple sensing cable packages 222 can be combined together, end to end, to span the entire length of the tube 109. The guide tube 240 may be sprayed with thermal sprays to mitigate potential delamination of the guide tube 240 from the shims 242, and the shims 242 from the tube 109. The first thermal spray may consist of a base coat of Metco 443, the second thermal spray may consist of alumina.

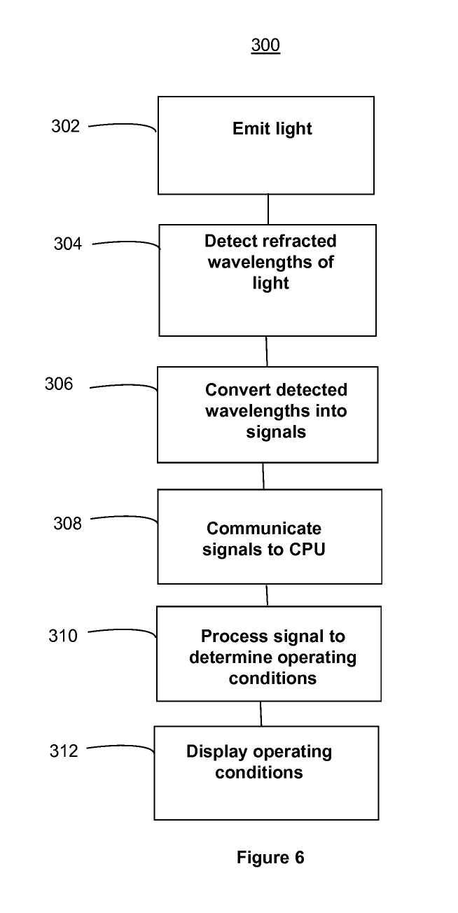

FIG. 6 is a flowchart of a process 300 for monitoring the operating conditions of the tubes 209 in the OTSG 200 of the system of FIG. 2, according to the present invention. The process 300 comprises the steps of emitting 302 light into a plurality of fiber optic sensors 210, detecting 304 wavelengths of the light, converting 306 the detected wavelengths of multiplexed signals into individual sensor signals using a peak tracking algorithm, communicating 308 the signal to a central processing unit 262 (also known as a computer processing unit or CPU), processing 310 the signal to monitor and determine the operating conditions of the tubes 209, and displaying 312 the operating conditions on a display.

In the step of emitting 302, the light is emitted by the light source 258 through the junction box 254 and into each of the fiber optic sensors 210. The light travels down the core 214 of each of the fiber optic sensors 210. Upon encountering gratings 218, certain wavelengths of the light reflect and the other wavelengths refract. What wavelengths reflect and refract depends upon the properties of the grating 218 the spacing between the gratings 218, and the operating conditions of the tubes 209. In this way, the fiber optic sensors 210 sense the strain in the tubes 209. The refracted wavelengths cascade through each grating 218 and travel back up the core 214 of the fiber optic sensors 210, through the junction box 254 and into the optical sensing interrogator 256.

Each grating 218, in effect, acts as an individual temperature and/or strain sensor. In an embodiment of this invention, each grating 218 is arranged to reflect slightly different wavelengths of light from the other gratings 218 that are also along the length of the fiber optic sensor 210. In this way, reflected light from a particular grating 218 (and therefore the temperature and pressure sensed by that particular grating at a particular measurement location along the tube 209) can be differentiated from the light reflected by the other gratings 218. The range of light wavelengths each grating 218 is arranged to reflect, depends upon the number of gratings 218 in the fiber optic sensor 210, the bandwidth of the light source 258, and the variance in wavelengths, due to temperature and pressure strains, the gratings 218 are expected to reflect.

In the step of detecting 304, the light detectors 260 in the interrogator 256 detect the refracted wavelengths of light.

In the steps of converting 306 and communicating 308, the detected wavelengths of light are converted into a digital signal and communicated to the CPU 262. In example embodiments, communication may occur through any or all of sending and/or receiving electrical signals, optical signals, or wireless signals.

In the step of processing 310 and displaying 312, the CPU 262 processes the signal to determine the operating conditions of the tube 209 at a specific point in time and displays 209 the operating conditions on a display 264.

A grating typically has a sinusoidal refractive index variation over a defined length. The reflected wavelength λ_{B} of the pulse of light is defined by the equation

λ_{B}=2nₑΛ,

where nₑ is the effective refractive index of the fiber Bragg grating, and
Λ is the grating period.

The bandwidth is defined by the equation

$$Δ λ = [ \frac{2 δ {n}_{0} n}{π} ] {λ}_{B} ,$$

where
δn₀ is the variation in the refractive index (i.e. n₂−n₁), and
n is the fraction of power in the fiber core.

High-temperature fiber optic sensors 210, as described in this embodiment, may be multi-functional. They are sensitive to both temperature and pressure strain such that a change in either or both at any grating point along the length of the fiber optic sensor 210 causes a relative shift in the wavelength of light reflected at that grating 218. If the wavelength shift at time initial t(0) is X(t(0)), then, the wavelength shift of fiber optic sensors 210 in response to both temperature and pressure strain at any moment, t, is defined according to the following equation:

Δλ_{B}(t)=K_{ε}ε(t)+KₜΔT(t),Δλ_{B}(t)=λ(t)−λ(t(0)), and ΔT(t)=T(t)−T(t(0)), where

K_{E} is the fiber sensor strain sensitivity
ε(t) is the thermal strain effect at time t
Kₜ is the temperature sensitivity, and
ΔT is the relative temperature variation at time t.

Where a fiber optic sensor is under a pressure strain-free condition, whether the fiber optic sensor experiences either a linear or nonlinear wavelength shift depends upon the external temperature. In general, a polynomial function up to order 3 could satisfy most of the calibration needs for the following equations

Δλ_{B}(t)=a+b·ΔT(t)+c·ΔT²(t)+d·ΔT³(t),

where a, b, c and d are constants determined during calibration.

If the fiber optic sensor 210 is under a pressure strain due to the way in which the sensor package is deployed, the wavelength shift is just a function of the surface temperature of the tube 209. In such a case, the temperature sensitivity, Kₜ will be dominated by the coefficient of thermal expansion of the sensor package and tube. A fiber optic sensor 220 can detect thermal strains and the instrumentation 250 can measure the extent to which, a tube 209 deforms or ruptures.

A pressure strain due to tube deformation at a constant temperature is described by the following equation: λ(T, t)=λ(T)+K_{ε}ε(t). The shift in the wavelength of reflected light is occurs slowly which reflects the gradual mechanical deformation of the tube.

A pressure strain due to a tube rupture is described by the following equation:

λ(T,t)=λ(T₀)+K_{ε}ε(t), where

T₀ is a specific steam tube operation temperature. In this event, the fiber optic sensor long-term trend suddenly returns to strain-free status, or induces some discontinuous drop in the fiber optic sensor response.

Both a slow response, a varied response, and an unexpected discontinuous response, are combined when conducting tube thermal degradation analysis. For example, the average tube temperature from all of the fiber optic sensors can be used to determine the general trend of the degree of fouling formation, while each individual fiber optic sensor in each tube can be used for local hot spot detection.

In the step of converting 306, the reflected wavelengths are multiplexed through wavelength domain signal analysis technology.

In the step of processing 310, the above-noted equations are used to determine various operating conditions of the tube 209. Operating conditions include, but are not limited to, the local temperatures and changes in local temperatures of a point on the tube 209 at each grating 218; the local strain and changes in local strain of a point on the tube 209 at each grating 218; thermal trends of a tube 209; localized hot spots; dynamic thermal events; and transient thermal events.

The process of monitoring the operating conditions of the tubes 209 in the OTSG 200 of the system of FIG. 2 can also include making and tracking one or more of the following measurements:

a. steam generator tube average temperature, which is useful for monitoring fouling formation or fouling trends using long term data analysis;
b. local temperatures at the steam generator tube, as determined for example by fiber optic sensors, which is useful for monitoring hot spot formation and propagation,
c. static (or long term) thermal strain, or static strain trend, of the steam generator tube, which is useful for monitoring mechanical degradation of the steam generator tube over time; and,
d. dynamic thermal strain of the steam generator tube, which is useful for detecting tube ruptures or potential tube ruptures.

One or more of these measurements or trends in these measurements can be compared to threshold temperatures or trends. The threshold temperatures or trends may vary with the feed water or gas temperature. Measurements beyond the thresholds trigger a warning or report. Optionally or additionally, static and dynamic signals such as strain signals can be analyzed together and compared to pre-set limit values.

Prior to deploying fiber optic sensors 210 as shown in FIG. 2, each fiber optic sensor 210 needs to be calibrated in a laboratory. During calibration, the calibration variables a, b, c, and d are determined through running simulations. When the fiber sensing package 210 is deployed in a steam generator, the strain on the fiber optic sensor 210 needs to be equivalent to the strain on the fiber optic sensor 210 in the laboratory during calibration so that the calibration variables a, b, c, and d are correct.

Individual sections of the OTSG 100 may be larger or smaller based on the heat load received from the gas turbine. The location of the tubes 109 as built or observed during operation may differ from locations shown in computer-aided design (CAD) models of the HRSG system or components thereof. Furthermore, the location of the tubes 109 may be affected due to expansion and contraction of tubes due to operating conditions and heat, and manufacturing variations.

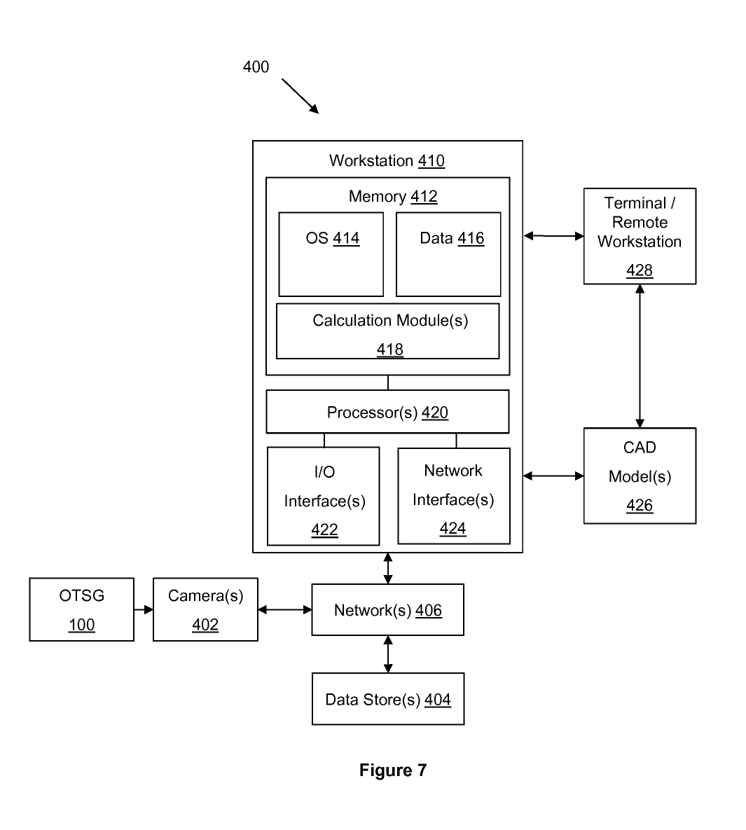

FIG. 7 shows a system 400 for monitoring operating conditions for tubes 109 in a HRSG, such as the OTSG 100 of FIG. 1A. The system 400 comprises one or more cameras 402, a data store 404, a network 406, and a workstation 410. A workstation can be an type of computer or computer processing unit.

The cameras 402 are located in, or proximate to, the OTSG 100A for taking images (pictures) of the tubes 109. At least some of the images (thermal images) show the infrared photon count of the tubes 109 at various points or segments along the tubes' 109 lengths. The cameras 402 are in communication with the workstation 410 and data store 404 via the network 406. Images taken by the cameras 402 are communicated to the workstation 410 and data store 404 through the network 406.

The workstation 410 receives and processes the images from the cameras 402. The workstation 410 comprises a memory 412, a processor 420, an input/output interface 422, and a network interface 424 in communication with the network 406. The memory 412 comprises an operating system 414, data 416, and one or more calculation modules 418. The calculation modules 418 can convert the infrared photon count of the tubes 109 as shown in the images to temperatures using emissivity maps, can help determine location data for tubes, and can monitor the operating conditions in the OTSG 100. The data store 404 or memory 412 can store images or other data including, without limitation, CAD models 426 associated with the tubes of the OTSG 100.

At least some of the cameras 402 are infrared cameras. The infrared cameras 402 may be middle-infrared (MIR) thermography image cameras with a wide angle view. Some of the cameras 402 may be optical, or non-infrared, cameras. The cameras 402 capture thermal images of the interior of a radiant section 112, or furnace, of the OTSG 100. Although better suited for use in the radiant section, the cameras may also capture thermal images of the interior of the convention section 110 of the OTSG 100. A comparison of the temperatures of tubes 109 is performed using the thermal images of a large area of the OTSG 100.

Middle-length waveband thermography imaging technology can be used to monitor sections of the OTSG 100 that experience extreme temperatures due to fuel flaming in the radiant section 112. Flaming may obscure an image captured by a camera 402. One or more of the cameras 402 can be configured to take thermal images with a wavelength range around 3.9 microns. The thermal images can also be filtered with a band pass filter of +/−10 nanometers. For example, a 1000 pixel by 1000 pixel thermal image may be produced.

The cameras 402 may be located in a housing mounted on an inner wall of the circuit 102, just outside the OTSG 100 radiant section 112. This location reduces the amount of heat to which the cameras 402 are exposed. The housing and cameras 402 may be cooled with air from outside the circuit 102. The camera housing may also be insulated from the inside of the circuit 102 to reduce the amount of heat to which the cameras 402 are exposed. The cameras 402 can be arranged to rotate about one or more axes to view different sections and angles of the tubes 109. The cameras 402 include equipment for communication with the workstation 410 via the network 406 or other direct or wireless inputs to the workstation 410. The cameras 402 may communicate directly with the workstation 410 via input/output interfaces 422.

Although the cameras 402 are most useful for monitoring the OTSG 100 during operation, the cameras 402 can also be used when maintenance is being performed on the tubes 109 to measure the residual heat in the tubes 109.

The images can help determine, among other things, the temperatures of, and anomalies in, segments of the tubes 109. For example, segments of a tube 109 which are at a higher temperature or have a higher infrared photon count than the same segments in previous images may indicate that the segment of the tube 109 is or is becoming fouled (fouled segment). Similarly, segments of a tube 109 which are at a higher temperature or have a higher infrared photon count than surrounding segments of the same tube, or segments of other tubes 109 may indicate that the segment of the tube 109 is or is becoming fouled.

It may be difficult for a user, however, to continually monitor the tubes 109 by simply observing the images of the tubes 109 and manually performing comparisons between segments over time. For example, it may be difficult for a user to determine the physical location, orientation, and geometry of the same segments of the tubes 109 in the OTSG 100 based solely on the images taken by the cameras 402. This is because the images are two-dimensional representations of the three-dimensional OTSG 100. The images depend on the position, orientation and characteristics of the cameras 402 in relation to the tubes 109 at the time the image is captured. A user may also have difficulty noticing small changes in segments of tubes 109 over time. Even if a user detects a fouled segment, it is important that the images showing the fouled segment can be reconciled with the physical environment of the OTSG 100 for, among other things, performing repairs to the tubes 109.

Accordingly, in an embodiment, the system 400 assists a user in monitoring the operating conditions of tubes 109 in an OTSG 100.

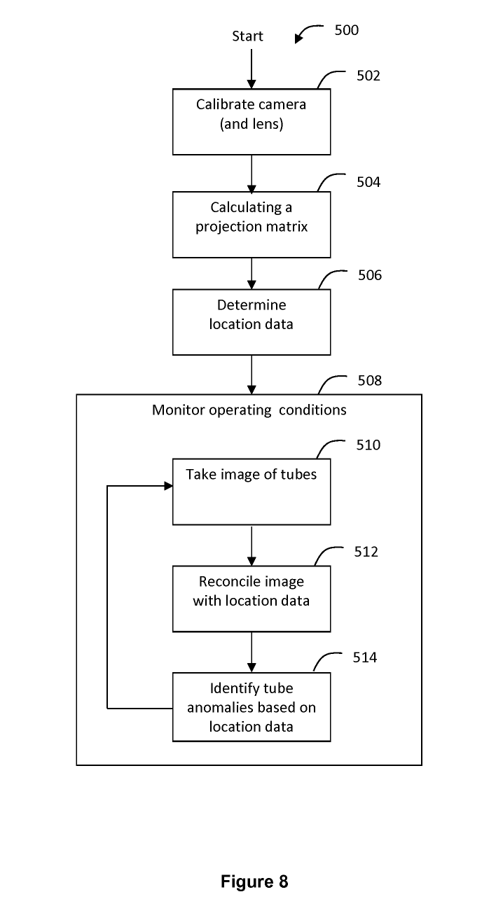

Computer Aided Design (CAD) models 426 comprising the locations of the tubes 109 are loaded into the workstation 410 by a terminal or remote workstation 428. Alternatively, the CAD models 426 may already be present in the workstation 410. The CAD models 426 comprise three-dimensional shape, design, location and construction parameters of some or all of the objects in the OTSG 100 such as tubes 109, supporting frame, and burner. Images of the tubes 109, that are in the field of view of the cameras 402, are also loaded into the workstation 410. The images are combined with the CAD models 426 using the calculation module(s) 418 according to the method 500 described below in relation to FIG. 8 to determine location data and monitor operating conditions in the OTSG 100.

The CAD models 426 may be used during operation of the OTSG 100. Alternatively, the CAD models 426 may be used during an initialization step which produces a camera model, the camera model containing the identity of tubes 109, or portions of them, as indicated in the CAD models 426 but correlated to parts of the image returned by a camera viewing the OTSG 100. In this case, the camera model may be used during operation of the OTSG 100, and adjusted in time as required by changes in the image, without reference back to the original CAD models 426. In the camera model, locations in an image sent by the camera, or a translation of the image, are correlated with the identity of a tube in the actual OTSG 100. The identity of the tube 109 may be specified by its location data as specified on the CAD model 426. A pixel indicating an overly high temperature in a location in the image corresponding to a real tube 109 thus indicates that the tube 109 is hot and possibly fouled or scaled. In the description below, the CAD models 426 may refer to the original CAD models 426 or a substituted model such as the camera model.

FIG. 8 shows a flowchart 500 of a method for monitoring the operation conditions in a HRSG or OTSG 100 using the system 400 of FIG. 7. The method comprises calibrating 502 the cameras 402 and their lenses, calculating a projection matrix 504 from a CAD model 426 and image, determining location data 506, and monitoring the operating conditions 508 in the OTSG 100. The step of monitoring operation conditions in the OTSG 508 comprises continuously performing the steps of taking an image 510 of the tubes 109, reconciling the image with the location data 512, and identifying tube anomalies 514 based on the location data.

Distortion from the lens (such as when using a wide angle or macro lens) and/or camera 402 may affect the accuracy of location data. The step of calibrating 502 the camera and lens, accordingly, includes calibrating the camera 402 to reduce camera lens distortion characteristic such as, for example, tangential distortion and radial distortion. A camera calibration toolbox such as Jean-Yves Bouguet Camera Calibration Toolbox for Matlab can be used. The step of calibration 502 can be performed in a lab prior to deployment of the camera 402, and can be performed in the field after deployment of the camera 402.

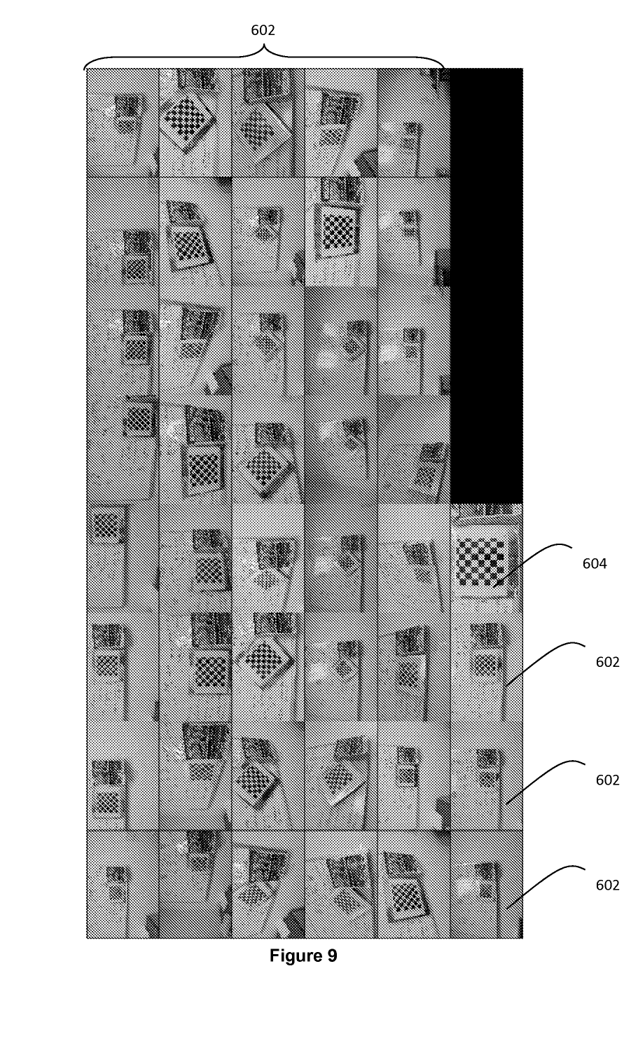

FIG. 9 shows images 602 of a planar checkerboard used for the step of calibrating 502 the cameras 402. The calibrated image is shown at 604. To incorporate sufficient information for the step of calibration 502, images 602 of the checkerboard in different sizes, positions, rotations and viewpoints should are used.

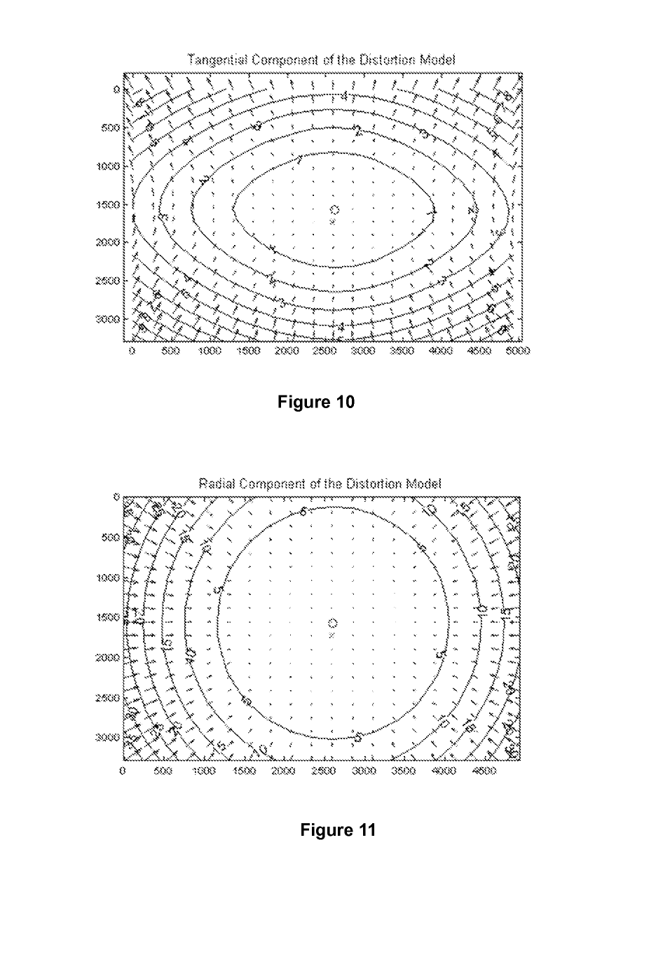

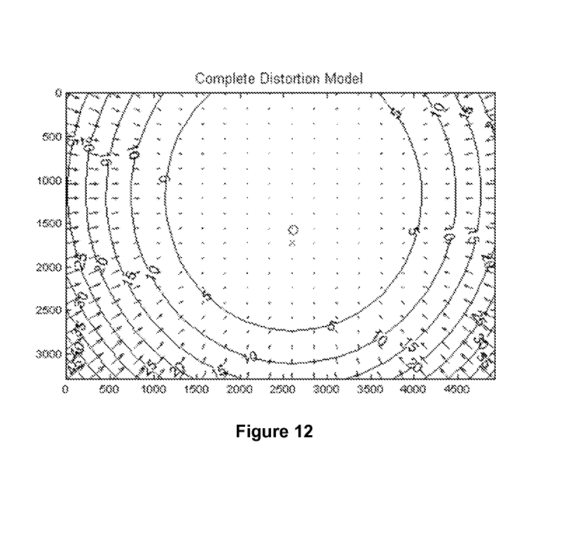

FIG. 10 through FIG. 12 show the tangential, radial, and combined tangential and radial components of the camera lens distortion functions and characteristic, respectively.

Based on the step of calibration 502, lens distortion parameters \vec{p} are determined. The lens distortion parameter can be combined with a projection matrix for correcting for lens distortions in images captured by the camera 402.

A projection matrix is a mathematical transformation for mapping real world objects, as shown in the CAD model 426, into two-dimensional representations in the image of the OTSG 100.

Referring again to FIG. 8, the step of calculating a projection matrix 504 comprises obtaining an image of tubes 109 in the OTSG 100; manually selecting landmarks in the image and correlating with known locations in a CAD model 426 of the OTSG 100; and using a least square method to calculate the projection matrix.

The relationship among the image, the CAD model, lens distortions and other calibration parameters is represented by the following equation:

$$[ \begin{matrix}u \\ v\end{matrix} ] = D ( [ \begin{matrix}{α}_{x} & s & {x}_{0} \\ 0 & {α}_{y} & {y}_{0}\end{matrix} ] [ \begin{matrix}{X}^{′} \\ {Y}^{′} \\ {Z}^{′}\end{matrix} ] , \vec{p} ) \qquad ( 1 )$$

where u and v are points (coordinates) in the image,
function D(•) is the lens distortion function and \vec{p} is the lens distortion parameter.
matrix

$$[ \begin{matrix}{α}_{x} & s & {x}_{0} \\ 0 & {α}_{y} & {y}_{0}\end{matrix} ]$$

is the projection matrix wherein αₓ and α_{y} are focal length of the camera, s is the skew parameter, x₀ and y₀ are the image center, and
X′ Y′ and Z′ are the three-dimensional points (coordinates) in the camera coordinate system.

The projection matrix can be calculated using the techniques described by Richard Hartley and Andrew Zisserman in Multi-view geometry in Computer Vision, Cambridge University Press, 2004.

FIG. 13 is an image 1000 of tubes 1004 in the interior of a radiant section 112 of the OTSG 100 as shown in FIG. 1C. To calculate the projection matrix, at least three landmarks 1006 in the image 1000 are identified or selected. The landmarks have two dimensional coordinates u,v. The landmarks 1006 corresponds to known locations 1008 (having three-dimensional coordinates) in the CAD model 426. In FIG. 13, the landmarks 1006 and known locations 1008 are the endpoints of the top of the tubes 1004. The landmarks cannot correspond to known locations in the CAD model 416 forming a line.

An equation for each pair of corresponding landmark 1006 and known location 1008 is created by inputting the corresponding two-dimensional and three-dimensional values into equation 1. The least square algorithm is then to calculate the projection matrix from the partially solved equations. The least square algorithm is also described by Richard Hartley and Andrew Zisserman in Multi-view geometry in Computer Vision, Cambridge University Press, March 2004. Once the projection matrix is obtained, given any three-dimensional point X′ Y′ and Z′ in the CAD model 426, the corresponding two-dimensional point u,v in the image 1000 can be determined.

Referring again to FIG. 8, the method 500 also comprises the step of determining location data 506. Once the projection matrix has been calculated, location data can be determined 506 by the system using equation 1. The location data is a virtual model of the OTSG 100 in the memory 412 of the workstation 410. The virtual model is created from the image and the projection of elements in the CAD Model 426 into the coordinate system of the image using equation 1.

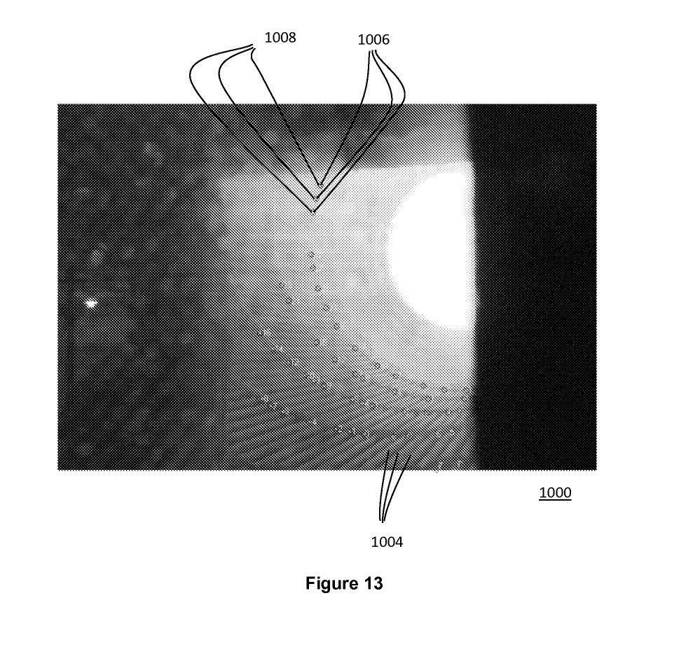

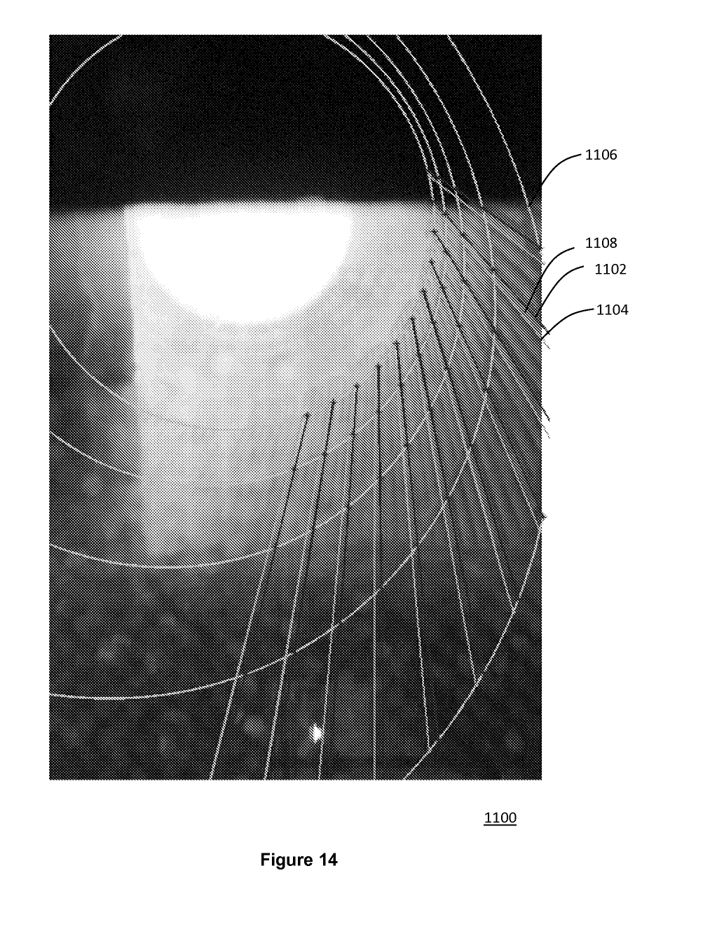

FIG. 14 shows the projection of objects in a CAD model 426 onto an image 1100 using equation 1. Specifically, lines 1102 and 1104 are the estimated positions of the right and left sides, respectively, of a tube 1108 in the image 1100 from projecting tubes in the CAD model 426 onto the image using equation 1. Similarly, circles 1106 are the estimated positions of rings positioned among different sections of tubes 109 in the image 1100 from projecting the CAD model 426 onto the image 1100 using equation 1. This projection allows the workstation 410 to localize tubes 109 and other objects such as the rings 1106 in the image 1100 to create a virtual model.

The virtual model may be an array of objects in the memory 412 of the workstation 410, each object corresponding to a segment of a tube 109 in the OTSG 100. The segment may be identified as the portion of tube 109 in an image outlined by two rings 1106 and the right and left side 1102, 1104 projections of the CAD Model 416. Each object may comprise four u,v coordinates which correspond to the four corners of a segment of a tube 109 in an image. Each object may also comprise an array for storing infrared photon counts or temperatures for the corresponding segment of tube 109 over time. Other data in the CAD Model 426 may also be stored in the objects such as, for example, tube 109 labels.

The projection matrix can be used via equation 1 for obtaining extrinsic parameters such as, for example, the intensity of a pixel in an image, and an angle and distance of the camera 402 to the object of interest. The intensity of a pixel in a given thermal image depends not only on the heat at the corresponding segment in the tube 109, but also on the segment's angle to, and distance from, the camera 402. The step of calibration 502 may also include adjusting for extrinsic parameters.

Once location data is determined 506, the operating conditions in the OTSG 100 are monitored 508. To monitor operating conditions, an image is taken of the tubes 109 by the camera 402. The image is sent to the workstation 410 for reconciling 512 with the CAD model 426 and location data 506.

When an OTSG 100 first commences operation, tubes 109 and other objects in the CAD models 426 may accurately reflect the actual location of tubes 109 and other objects in the OTSG 100. Over the course of time, however, the CAD model 426 may not accurately reflect the OTSG 100. For example, the location of tubes 109 may change due to the thermal expansion and contraction of tubes 109, repairs, manufacturing variations, changes in the refraction index due to the heated air in the OTSG 100, or slight movement of the camera 402 over time. Noise in images and systematic errors may also further affect the accuracy of the CAD model 426. Orientation of the tubes 109 in the OTSG 100, and the proximity of the camera 402 to the tubes 109, may also cause images of the tubes 109 to become distorted. For example, the closer the camera 402 is to the tubes 109, the wider and longer the tubes 109 will appear in the image. Accurate localization of each tube 109 in each image is required to detect anomalies such as fouling during real-time operations. Accordingly, reconciling the image with location data is desirable.

The step of reconciling the image 512 is performed by projecting the CAD model 426 onto the image then locally fitting a parametric template (also known as a tube template) to the tubes 109. Since the relevant perspective geometry of the CAD model 426 is already known based on the projection matrix and equation 1, a parametric template can be locally fitted to refine the true locations of the tubes 109. In an embodiment, the CAD model 426 is combined with parametric template to identify the four new u,v coordinates of the segment of a tube 109. The new coordinates are used to identify information in the corresponding image such as the photon count or temperature of pixels. The information is retained in the virtual model.

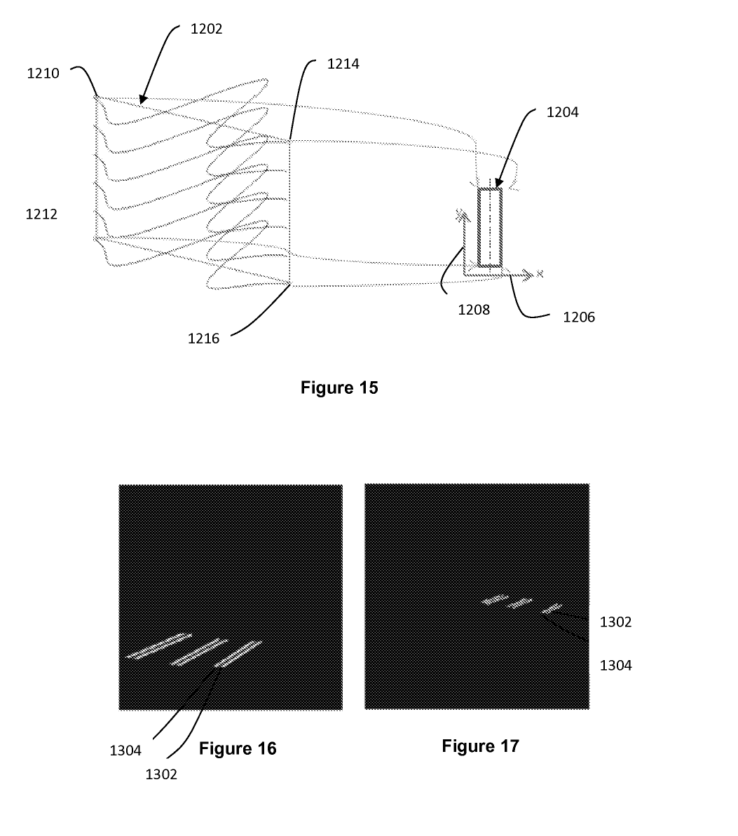

FIG. 15 shows a schematic view of a tube template transformation for the step of adjusting location data 510 according to the method of FIG. 8. The parametric template may be designed to match to an ideal tube to create an ideal tube template 1204 that is orthogonal to an optical axis 1204 of the camera 402. The ideal tube template 1204 has a constant value longitudinally (Y axis shown as 1208) and has a difference of Gaussians (DOG) shape across the tube 109 (X axis shown as 1206 in FIG. 15), and thus enables cylindrical objects to be detected. The DOG may be calculated in one dimension, defined by the following equation:

$$f ( k ; μ , {σ}_{1} , {σ}_{2} ) = \frac{1}{{σ}_{1 \sqrt{2 π}}} exp ( - \frac{{( k - μ )}^{2}}{2 {σ}_{1}^{2}} ) - \frac{1}{{σ}_{2 \sqrt{2 π}}} exp ( - \frac{{( k - μ )}^{2}}{2 {σ}_{2}^{2}} ) \qquad ( 2 )$$

where k is the coordinate along the crossline of the tube 109 (k is along the X axis shown as 1206 in FIG. 15), μ is the mean of both of the Gaussians, which is the coordinate of the middle line (dash line shown as 1204 in FIG. 15) of the tube 109, and σ₁ and σ₂ are the bandwidths for the two Gaussians respectively.

Since the perspective geometry of each tube 109 is known, four corners of each tube 109 may be used to determine an affine mapping from the ideal tube template 1204 to each located tube template 1202. The located tube template 1202 having four corners 1210, 1212, 1214, and 1216. The parameters of the affine transformation may be estimated using the least squares fitting algorithm. It is assumed that the angular variations along each tube are minimal. The affine model may handle width variations along the tube. The bandwidth of Gaussian filters that form the DOG may be designed so that the highest peak of the tube template is in the middle of tubes 109 and the lowest peaks of the tube template is at the two sides of the tubes 109.

FIG. 16 and FIG. 17 are schematic views of an example of the use of the tube templates, in the near and far fields, respectively. The tube template is properly located in the image, as shown by regions 1304 of higher weights (and therefore intensity) and regions 1302 of lower weights.

To adjust the location of tubes 109 in the template, the local maxima of a template score may be used. The local maxima is defined as the weighted sum of intensities with weights given by the DOG filters, given by Equation 3:

$$R ( A ) = {\sum }_{x , y ∈ T} I ( A [ \begin{matrix}x \\ y \\ 1\end{matrix} ] ) \times w ( A [ \begin{matrix}x \\ y \\ 1\end{matrix} ] ) \qquad ( 3 )$$

where T is the set template locations, I(.,.) represents the intensity of the image at a given position, w(.,.) is the weights determined by the DOG filter after a transformation A that can be defined in several ways; in one embodiment A can be defined as an unconstraint transformation

$$A = [ \begin{matrix}{a}_{11} & {a}_{12} & {a}_{13} \\ {a}_{21} & {a}_{22} & {a}_{23}\end{matrix} ] ,$$

or in another embodiment A can be defined as a constraint transformation modeling only rotation and translation,

$$A = [ \begin{matrix}cos ( θ ) & - sin ( θ ) & {t}_{x} \\ sin ( θ ) & cos ( θ ) & {t}_{y}\end{matrix} ] ,$$

where θ is the rotation between the template and the image, and tₓ and t_{y} are the translation along x and y directions, respectively.

To find the local maxima, a projected template may be locally adjusted by slightly rotating and shifting the tubes. In each instance, a template matching score is obtained. The local maximum is the one with the highest score, which is also selected as the location of the tube. This process may be defined in Equation 4 as:

A_{best}=argMaX_{A}_{ᵢ}_{εγ}R(Aᵢ) (4)

where γ is the whole set of local rotation and shift parameters and Aᵢ is one instance of these parameters within the search range. The final tube location is defined as A_{best}, which corresponds to the local maximum of the template score.

Equation 4 refines the tube 109 locations individually. This makes the refinement sensitive to the local intensity noises. Also, due to the low contrast and blurring of the image, the refinement of a single tube may be incorrect. To make it more robust, the response of several tubes may be combined together, to refine the location for all of them, according to the equation:

γ_{best}=argmax_{γ}_{ᵢ}_{εT}Σ_{T}_{ⱼ}_{εN(T}_{ₖ})R(γᵢ(Tⱼ)) (5)

where N(Tₖ) is a set of tubes' localizations, which are neighbors of Tₖ. Possible rotations and shifts may be enumerated. Then, the refinement of Tₖ's localization is determined by the local maximum of the template score for N (Tₖ).

For example, the robustness of adjustment or refinement was tested by determining a projection matrix from an image as described above and projecting the tubes 109 from a CAD model 426 onto the image. The image was then shifted 5 pixels in both x and y directions, so that the locations of projected tube 109 did not match the tubes 109 in the image. To refine the tubes' 109 locations, the estimated template was rotated every 5 degrees from −20 to 20 degrees and was shifted from −5 to 5 pixels every 2 pixels in both x and y directions.

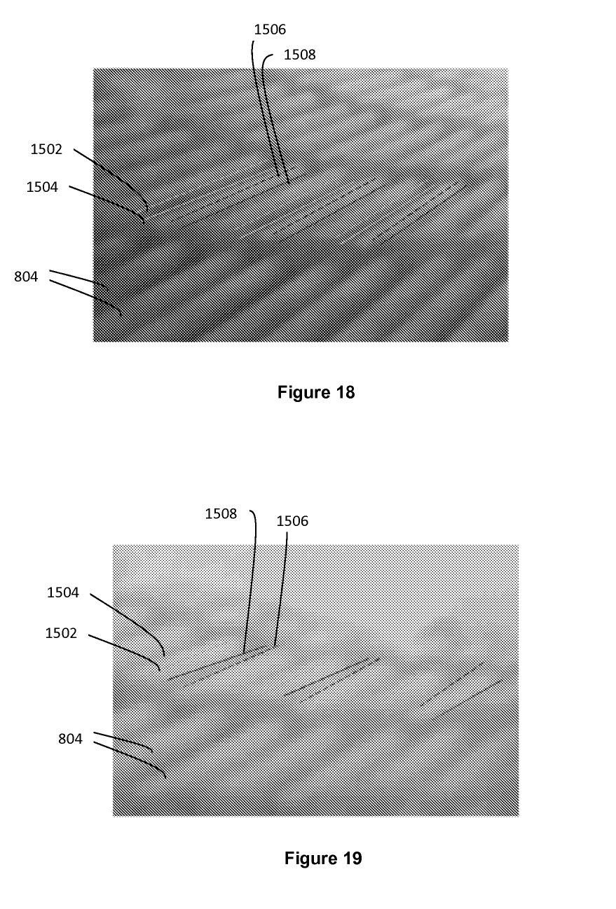

FIG. 18 and FIG. 19 show the refinement results based on a single tube 109. FIG. 18 illustrates the results of near field tubes 109, and FIG. 19 illustrates the results of far field. Lines 1504 are the left side of the tubes 109 and lines 1508 are the right side of the tubes 109. The dotted lines 1502 (for the left side) and 1506 (for the right side) are the perturbed tube locations for testing purposes; these perturbed locations are 5 pixels away from their true locations due to the shift of the image described above. The solid lines 1504 and 1508 are the results after the refinement. It is observed that the near field tubes 109 are correctly located (FIG. 18), but the ones in the far field are not (FIG. 19). This may be due to the low contrast of the image for the far field tubes 109.

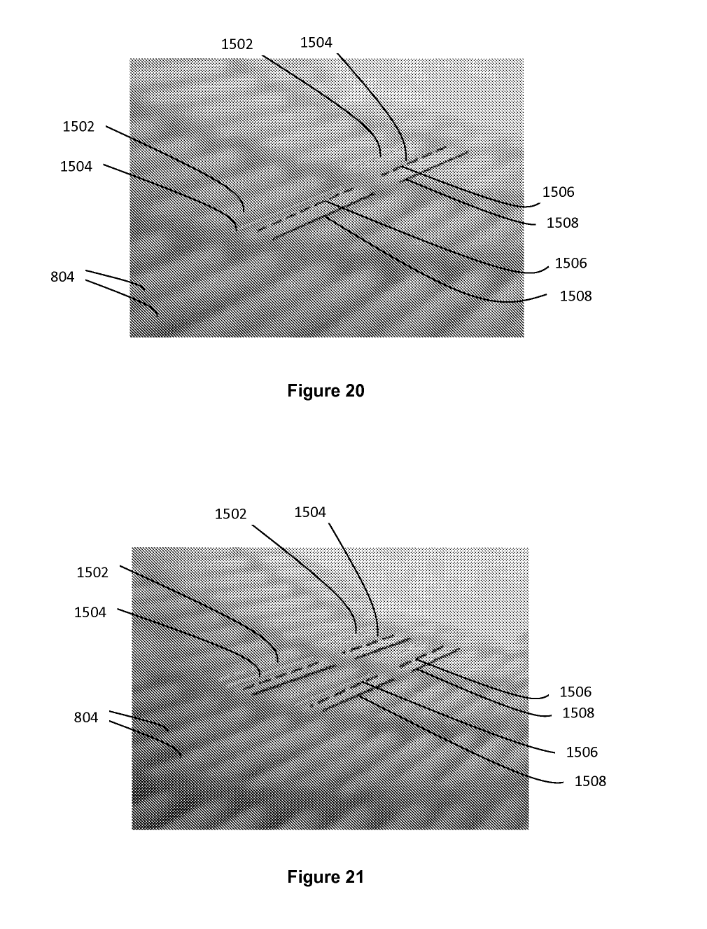

FIG. 20 and FIG. 21 illustrate the refinement based on multiple tubes 109, together. FIG. 20 and FIG. 21 illustrate the results of a two-tube combination and a four-tube combination separately, respectively. In both figures, the tubes in the CAD model 426 are located accurately in the image to match the tubes 109 shown therein.

Referring again to FIG. 8, once information from the image is retained in the virtual model, anomalies in the tubes 109 can be identified 514 using the location data. If an anomaly is detected, a user can be alerted.

Location data may be output, stored and/or used to monitor and diagnose hot spots, cold spots, or other symptoms of fouling or scaling in the tubes 109. The location data may be used by technicians to anticipate, schedule, or facilitate the repair or maintenance of the OTSG 100, to change or control one or more operations associated with the OTSG 100, to integrate the monitoring of the OTSG 100 with other processes, and to improve steam generation efficiency. Location data can also be used to efficiently repair the tubes 109 at the location where the repair is specifically needed such as, for example, the fouled segments. Location data can also be used to improve the accuracy of the thermal images by correcting for distances from, and viewing angles between, the tubes 109 and the cameras 402. Furthermore, once the location data has been determined, thermal measurements can be continuously taken to measure critical parameters related to fouling and deterioration of the tubes 109 such as tube temperatures, thermal trends, localized hot spots, dynamic and transient events, and the like.

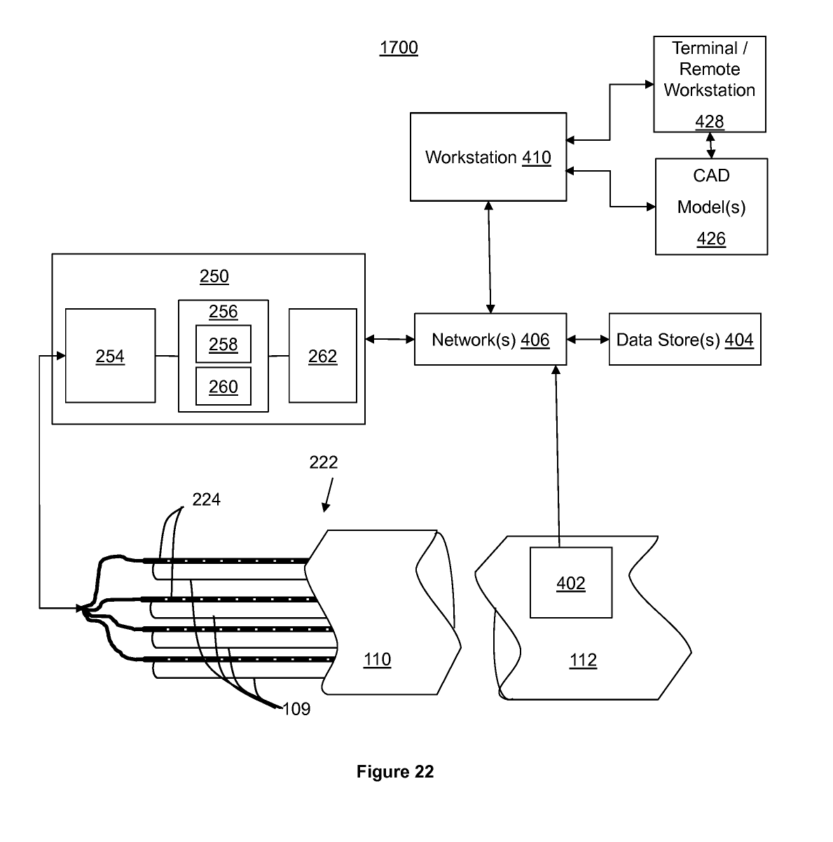

FIG. 22 shows an example embodiment of a system 1700 for monitoring the operating conditions of the radiant section 112 and convection section 110 of the OTSG 100 of FIG. 1A. The system 1700 comprises a plurality of the sensing cable packages 222 of FIG. 3, affixed to, or integrated with tubes 109 for monitoring operating conditions in a convection section 110, and one or more cameras 402 positioned proximate to the radiant section 112 for monitoring the operating conditions of tubes 109, therein. The sensing cable packages 222 are ideal for use in the convection section 110 because the tubes 109 therein are tightly spaced to one another and make a series of turns. The camera 402 is ideal for use in the radiant section 112 because the tubes 109 therein are straight and arranged circumferentially so that a large number of tubes 109 can be viewed by the camera 402 when situated at one location. The camera 402 is connected to a network 406. The sensing cable packages 222 are connected to instrumentation 250 which communicate with the network 406 through the CPU 262. The network 406 is connected to a workstation 410. The workstation 410 processes information about the operating conditions of the tubes 109 in the radiant section 112. The workstation 410 also processes information about the operating conditions of the tubes 109 in the convection section 110. In this way, the workstation 410 can monitor the operating conditions of tubes 109 in both sections 110 and 112 of the OTSG 100.

In example embodiments of the invention, the systems 200, 400, 700 may include any number of hardware and/or software applications that are executed to facilitate any of the operations. In example embodiments, one or more I/O interfaces may facilitate communication between the systems 200, 400, 700 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the systems 200, 400, 700. The one or more I/O interfaces may be utilized to receive or collect data and/or user instructions from a wide variety of input devices. Received data may be processed by one or more computer processors as desired in various embodiments of the invention and/or stored in one or more memory devices.

The above-described embodiments are intended to be examples only. Alterations, modifications and variations can be effected to the particular embodiments by those of skill in the art without departing from the scope, which is defined solely by the claims appended hereto. Furthermore, The invention is described above with reference to block and flow diagrams of systems, methods, and/or computer program products according to example embodiments of the invention. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-readable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for monitoring an operating condition of tubes in a steam generator, the system comprising:
fiber optic sensors affixed to the tubes, the sensors adapted for detecting one or more of mechanical strains, pressures, and temperatures in the tubes or sensors; or a camera positioned in the steam generator, the camera adapted for capturing images of the tubes relatable to temperature; or both the sensors and the camera; and
one or more computers connected to the sensors, or the camera, or both the sensors and the camera, the one or more computers adapted for receiving signals from the sensors or the camera or both, and monitoring the operating conditions of the tubes.

2. (canceled)

3. The system of claim 1 having fiber optic sensors and a camera, wherein the steam generator comprises a radiant section and a convention section, and wherein the sensors are affixed to tubes in the radiant section and the camera is positioned to capture thermal images of the tubes in the convention section.

4. The system of claim 1, wherein the one or more computers are configured to identify segments of the tubes to which pertain the one or more of mechanical strains, pressures and temperatures.

5. The system of claim 1, wherein the system comprises a camera and the one or more computers are configured to project a model of the tubes onto each image and locally fit a parametric template of the tubes in each image to identify segments of the tubes to which pertain infrared photon counts of the images.

6. The system of claim 5, wherein the one or more computers are configured to locally fit a parametric template to two or more tubes together in an image.

7. The system of claim 1, wherein the computer is configured to monitor one or more of the following operating conditions of the tubes:
a. temperatures;
b. pressures;
c. mechanical strain;
d. thermal trends;
e. mechanical degradation;
f. localized hot spots;
g. dynamic and transient events;
h. rupture events; and
i. fouled segments.
based on the one or more of the mechanical strains, pressures, and temperatures.

8.-10. (canceled)

11. A method for monitoring operating conditions of tubes in a steam generator, comprising:
receiving, at one or more times, one or more signals or images relatable to one or more of pressure, mechanical strain, and temperature of segments of the tubes;
identifying in a model of the steam generator the segments of the tubes which the signals or images related to; and
monitoring an operating condition of the tubes.

12. The method of claim 11, wherein monitoring an operating condition comprises detecting a difference between one or more of the pressure, mechanical strain, and temperature of one segment relative to another.

13. The method of claim 12, wherein a difference is detected by comparing one or more of the pressure, mechanical strain, and temperature of one or more of
a. a first segment of a first tube at a first time to the first segment of the first tube at a second time;
b. the first segment of the first tube to a second segment of the first tube; and
c. the first segment of the first tube to a second segment of a second tube.

14. The method of claim 11, further comprising steps of receiving infrared photon counts, which step further comprises receiving thermal images of the tubes, wherein the step of identifying segments comprises projecting a model of the tubes onto the image and locally fitting a parametric template to the image of the tubes to determine location data.

15. The method of claim 11, wherein the step of monitoring operation conditions comprises one or more of determining
a. tube temperatures,
b. thermal trends,
c. localized hot spots,
d. fouled segments, and
e. dynamic and transient events

16. The method of claim 14, further comprises a step of receiving a signal indicating a wavelength of light from a fiber optic sensor and converting the wavelength of the light into one or more of
a. temperatures of the tubes and the corresponding locations of the temperatures of the tubes; and
b. pressures in the tubes and the corresponding locations of the pressures in the tubes.

17. The method of claim 11, wherein the step of monitoring operation conditions comprises one or more of determining
a. average temperature and pressure measurements in the tubes;
b. thermal trend of the tubes;
c. mechanical degradation trend of the tubes;
d. localized hot spots in the tubes;
e. averaged tube temperature trends;
f. dynamic thermal events in the tubes; and
g. transient thermal rupture events in the tubes.

18.-19. (canceled)

20. A method comprising:
receiving at least one image, from a camera, of one or more tubes for carrying water in a steam generator;
registering a model of the one or more tubes onto the image to generate a projection of the model;
determining location data for the one or more tubes from the projection.

21. The method according to claim 20, further comprising calibrating the camera to reduce a camera lens distortion characteristic in the at least one image.

22. The method according to claim 21, wherein the camera lens distortion characteristic comprises at least one of tangential distortion and radial distortion.

23. The method according to claim 20, further comprising:
calibrating the camera to adjust an extrinsic parameter of the camera, the extrinsic parameter comprising at least one of the angle of the camera to each part represented by a pixel of the image, and the distance of the camera to each part represented by a pixel of the image.

24. The method according to claim 20, wherein the registering comprises:
receiving an identification of landmarks on the image that correspond to known locations in the model; and
generating the projection from the landmarks, the projection comprising a projection matrix from the image to points on the model.

25. The method according to claim 20, further comprising:
adjusting the location data using a model based tube template.

26. The method according to claim 25, wherein the adjusting comprises:
constructing a plurality of parametric templates for each of the one or more tubes;
evaluating the plurality of parametric templates against the location data to generate a response; and
adjusting the location data when the parametric template has a local best fit response.

27. The method according to claim 26, wherein the parametric template comprises a rotation parameter and a shift parameter.

28. The method according to claim 26, wherein the adjusting is dependent on the local best fit response for at least one neighbor tube.

29. The method according to claim 20, wherein the image comprises a thermal image and the camera comprises an infrared camera.

30. The method according to claim 29, further comprising:
receiving a sequences of thermal images captured by the infrared camera;
monitoring the sequence of thermal images for a change of temperature affecting one or more of the tubes; and
when a temperature change is detected, determining location data for the affected tube.

31.-37. (canceled)

38. A system for monitoring operating conditions of the steam generator tubes in a steam generator, the system comprising a fiber optic sensing array;
a hermetical cable package disposed circumferentially around the fiber optic sensing array;
a light source in optical communication for emitting a light into the fiber optic sensors;
a detector optically connected to the fiber optic sensing array for receiving refracted wavelengths of the light;
a central processing unit in communication with the photodetector, the central processing unit configured to receive a signal from the photodetector corresponding to the refracted wavelengths of light and further configured to convert the signal into the operating conditions; and
a display device operatively connected to the central processing unit for displaying the operating conditions.

39.-40. (canceled)

41. The system of claim 38, wherein the operating conditions comprise one or more of:
thermal strain and temperature measurements at multiple locations along a steam generator tube;
local and averaged temperature measurements and thermal strain measurement along a steam generator tube;
a thermal trend from a steam generator tube long-term operation performance;
mechanical degradation trend;
localized hot spot(s);
averaged steam generator tube temperature trend;
dynamic thermal event; and
transient thermal rupture event.

42.-49. (canceled)

50. A system for monitoring the operating conditions of a steam generator, the system comprising:
a network in communication with a workstation;
a plurality of fiber optic sensors for sensing strain information of tubes in a steam generator;
instrumentation connected to the fiber optic sensors for obtaining the strain information therefrom and communicating the strain information to the workstation through the network; and
a camera for detecting the temperature in a plurality of tubes in a steam generator, and for communicating the temperatures to the workstation through the network;
wherein, the workstation is configured to determine the operating conditions of the steam generator.

51. The system of claim 50, wherein the strain information is temperature and location data.

52. The system of claim 50, wherein the strain information is pressure strain and location data.

53. (canceled)

54. The system of claim 50, wherein the fiber optic sensors sense the strain information of tubes in a convection section of the steam generator.

55. The system of claim 50, wherein the camera sense the temperature of tubes in a radiant section of the steam generator.
